(19) United States
(12) Patent Application Publication
(10) Pub. No.: US 2022/0292375 A1
(43) Pub. Date: Sep. 15, 2022

(54) METHOD AND SYSTEM FOR IDENTIFYING PREDICTABLE FIELDS IN AN APPLICATION FOR MACHINE LEARNING

(71) Applicant: Tata Consultancy Services Limited, Mumbai (IN)

(72) Inventor: Reni PARAMESHWARAN, Kochi (IN)

(73) Assignee: Tata Consultancy Services Limited, Mumbai (IN)

(21) Appl. No.: 17/348,455

(22) Filed: Jun. 15, 2021

(30) Foreign Application Priority Data
Mar. 15, 2021 (IN) 202121010970

(51) Int. Cl. G06N 5/04; G06N 20/00; G06F 16/25

(52) U.S. Cl. CPC G06N 5/04; G06N 20/00; G06F 16/252

(57) ABSTRACT

This disclosure relates generally to identifying predictable fields in an application for machine learning (ML). With the availability of several choices for machine learning techniques, it is difficult to choose the most effective option on a specific application. In addition, the functionality/usage of fields within an application may vary across applications subject to the application's domain. Hence ML may not be efficient for all datatypes/fields. Therefore, the disclosure provides a method and system for identifying predictable fields in an application before ML technique for the predictable fields. The predictable fields are identified based on the domain of the application using a grouping technique, a pattern identification technique and optimization techniques. Further ML techniques are recommended only on identified predictable fields, thereby making the ML process more effective on the application in relevance with the application's domain.

### PRIORITY CLAIM

This U.S. patent application claims priority under 35 U.S.C. § 119 to: India Application No. 202121010970, filed on Mar. 15, 2021. The entire contents of the aforementioned application are incorporated herein by reference.

### TECHNICAL FIELD

The disclosure herein generally relates to artificial intelligence/machine learning, and, more particularly, to identifying predictable fields in an application for machine learning.

### BACKGROUND

For years, different methods are being explored to incorporate artificial intelligence (Al) to obtain data analytics. Machine learning (ML) is one of the popular known methods for analyzing data. Considering the growing need for data analytics, various machine learning algorithms/techniques are available and new machine learning algorithms are actively researched.

With the availability of several choices for machine learning techniques, it is difficult to choose the best option or the most effective option on a specific application. In addition, acceptable options are limited as the available machine learning options are generic and may not be efficient for all types of applications/data within the application. Further subject to the domain of the application, there is dependency on the data within each application before recommending a machine learning algorithm. Hence it is also important to understand the data within an application before recommending/applying machine learning to the application based on the domain.

Traditionally, machine learning activities are carried out by experts in siloes, thereby creating a dependency on the experts to understand the data within an application or the machine learning. Further in the digital era, since the applications are complex and many use legacy technologies, it is challenging even for the experts to understand applications of different the domains. In addition, the functionality/usage of datatype/fields within an application may vary across domains and hence ML may not be efficient for all datatypes/fields within the application. Hence there is a growing need to harness technology for understanding the underlying data from each application and recommend ML accordingly for the application based on its domain.

### SUMMARY

Embodiments of the present disclosure present technological improvements as solutions to one or more of the above-mentioned technical problems recognized by the inventors in conventional systems. For example, in one embodiment, a method for identifying predictable fields in an application for machine learning is provided. The method includes receiving a plurality of inputs associated with an application from a plurality of sources, the plurality of inputs comprising a plurality of predictability data attribute received from an application interface, a plurality of metadata from received from an application database and a plurality of data attributes received from an application analytical source and a domain knowledge associated with a domain of the application received from a domain database. The method further includes clustering the plurality of inputs based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns. The method further includes identifying at least one pattern in the grouped data based on the domain using a pattern identification technique, wherein the at least one pattern is identified based on comprises a correlation factor and a predictability factor for each of the plurality of columns within the grouped data. The method further includes optimizing the grouped data using an optimization technique based on the dimension to obtain an optimized grouped data. The method further includes identifying a plurality of predictable fields from the optimized grouped data for the domain based on the at least one pattern, wherein the plurality of predictable fields comprises a set of predictable columns that are predictable and relevant to the domain. The method further includes recommending a machine learning technique for the plurality of predictable fields using a machine learning recommendation technique, wherein the machine learning technique is recommended based on a predictability score.

In another aspect, a system for identifying predictable fields in an application for machine learning is provided. The system includes a memory storing instructions, one or more communication interfaces; and one or more hardware processors coupled to the memory via the one or more communication interfaces, wherein the one or more hardware processors are configured by the instructions to receive a plurality of inputs associated with an application from a plurality of sources, via a one or more hardware processors, the plurality of inputs comprising a plurality of predictability data attribute received from an application interface, a plurality of metadata from received from an application database and a plurality of data attributes received from an application analytical source and a domain knowledge associated with a domain of the application received from a domain database. The system is further configured to cluster the plurality of inputs, via a one or more hardware processors, based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns. The system is further configured to identify at least one pattern in the grouped data based on the domain using a pattern identification technique, wherein the at least one pattern is identified based on comprises a correlation factor and a predictability factor for each of the plurality of columns within the grouped data. The system is further configured to optimize the grouped data using an optimization technique based on the dimension to obtain an optimized grouped data. The system is further configured to identify a plurality of predictable fields from the optimized grouped data for the domain based on the at least one pattern, wherein the plurality of predictable fields comprises a set of predictable columns that are predictable and relevant to the domain. The system is further configured to recommend a machine learning technique for the plurality of predictable fields using a machine learning recommendation technique, wherein the machine learning technique is recommended based on a predictability score.

In yet another aspect, a non-transitory computer readable medium for identifying predictable fields in an application for machine learning is provided. The program includes receiving a plurality of inputs associated with an application from a plurality of sources, the plurality of inputs comprising a plurality of predictability data attribute received from an application interface, a plurality of metadata from received from an application database and a plurality of data attributes received from an application analytical source and a domain knowledge associated with a domain of the application received from a domain database. The program further includes clustering the plurality of inputs based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns.

The program further includes identifying at least one pattern in the grouped data based on the domain using a pattern identification technique, wherein the at least one pattern is identified based on comprises a correlation factor and a predictability factor for each of the plurality of columns within the grouped data. The program further includes optimizing the grouped data using an optimization technique based on the dimension to obtain an optimized grouped data. The program further includes identifying a plurality of predictable fields from the optimized grouped data for the domain based on the at least one pattern, wherein the plurality of predictable fields comprises a set of predictable columns that are predictable and relevant to the domain. The program further includes recommending a machine learning technique for the plurality of predictable fields using a machine learning recommendation technique, wherein the machine learning technique is recommended based on a predictability score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for identifying predictable fields in an application for machine learning according to some embodiments of the present disclosure.

FIG. 2 is a functional block diagram of the modules present in FIG. 1 for identifying predictable fields in an application for machine learning according to some embodiments of the present disclosure.

FIG. 3A and FIG. 3B is a flow diagram illustrating a method for identifying predictable fields in an application for machine learning in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears.

Wherever convenient, the same reference numbers are used throughout the drawings to refer to the same or like parts. While examples and features of disclosed principles are described herein, modifications, adaptations, and other implementations are possible without departing from the scope of the disclosed embodiments.

### Complete Description of Embodiments

Machine learning is one of the popular known method for analyzing data. With the availability of several choices for machine learning techniques, it is difficult to choose the best option or the most effective option on a specific application. In addition, acceptable options are limited as the available machine learning options are generic and may not be efficient for all types of applications/data within the application. In addition, the functionality/usage of fields within an application may vary across applications subject to the application's domain. In an example scenario, consider that a phone number field and a currency field are both stored as integers in the database table. Hence if the fields have been trained using a ML technique for “predict-ability” in a real world data analytics for business relevance, then it is important to classify the fields. Classification of data is important (as in the instance, phone number even though an integer cannot be predicted however predicting a currency value maybe of business significance). Hence it is also important to understand the data within an application based on the domain before recommending/applying machine learning to the application. Considering the growing need for efficient training in ML, it is now necessary to harness technology for understanding the underlying data from each application before recommending ML. Further, based on the above example scenario (phone number and currency), it can be understood that ML techniques provide efficient analytics on only certain fields for the application based on its domain.

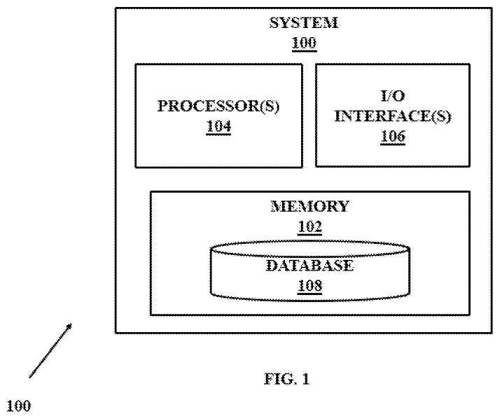

Referring now to the drawings, and more particularly to FIG. 1 through FIG. 3B where similar reference characters denote corresponding features consistently throughout the figures, there are shown preferred embodiments and these embodiments are described in the context of the following exemplary system and/or method.

FIG. 1 is a functional block diagram of a system 100 for identifying predictable fields in an application for machine learning in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 is configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, a network cloud and the like.

The I/O interface(s) 106 can include a variety of software and hardware interfaces, for example, a web interface, a graphical user interface, a touch user interface (TUI) and the like and can facilitate multiple communications within a wide variety of networks N/W and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the memory 102 may include a database 108. Thus, the memory 102 may comprise information pertaining to input(s)/output(s) of each step performed by the processor(s) 104 of the system 100 and methods of the present disclosure. In an embodiment, the database 108 may be external (not shown) to the system 100 and coupled to the system via the I/O interface 106.

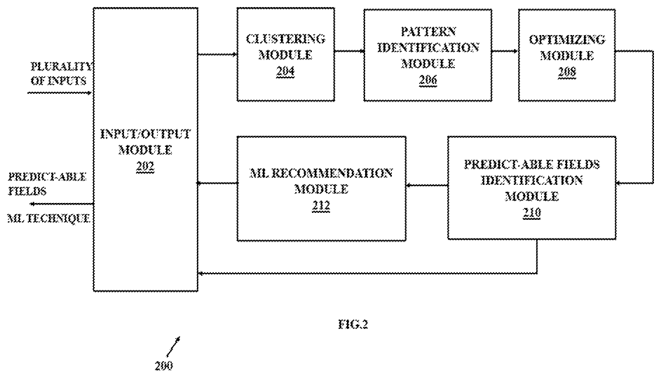

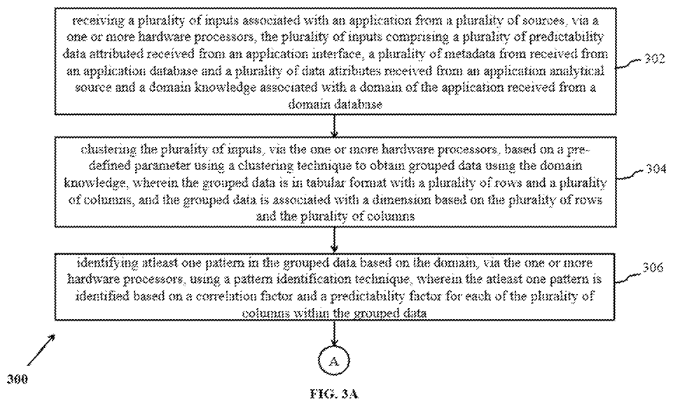

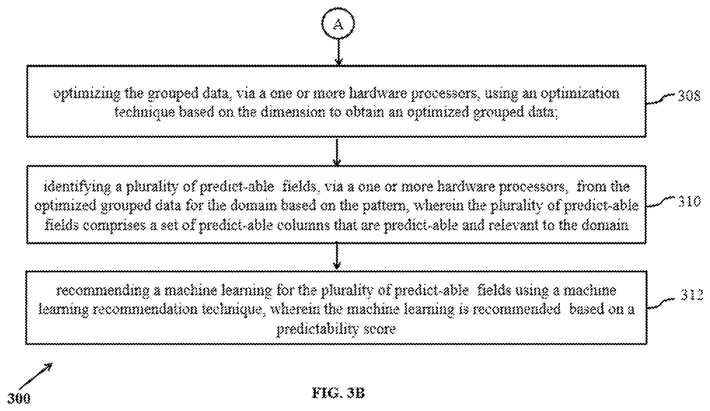

Functions of the components of system 100 are explained in conjunction with functional overview of the system 100 in FIG. 2 and flow diagram of FIGS. 3A and 3B for identifying predictable fields in an application for machine learning.

The system 100 supports various connectivity options such as BLUETOOTH®, USB, ZigBee and other cellular services. The network environment enables connection of various components of the system 100 using any communication link including Internet, WAN, MAN, and so on. In an exemplary embodiment, the system 100 is implemented to operate as a stand-alone device. In another embodiment, the system 100 may be implemented to work as a loosely coupled device to a smart computing environment. The components and functionalities of the system 100 are described further in detail.

FIG. 2 is a functional block diagram of various modules of the system of FIG. 1, in accordance with some embodiments of the present disclosure. As depicted in the architecture, the FIG. 2 illustrates the functions of the components of the system 100 that is configured for identifying predictable fields in an application for machine learning.

The system 200 for identifying predictable fields in an application for machine learning is configured for receiving a plurality of inputs associated with an application from a plurality of sources using an input/output module 202. The received plurality of inputs is clustered in a clustering module 204 of the system 200 based on a pre-defined parameter using a clustering technique to obtain grouped data using the domain knowledge. Further at least one pattern is identified in the grouped data based on the domain in a pattern identification module 206 of the system 200 using a pattern identification technique. Further the grouped data is optimized optimizing module 208, using an optimization technique based on the dimension to obtain an optimized grouped data. Further a plurality of predictable fields is identified from the optimized grouped data for the domain based on the pattern in a predictable fields identification module 210 of the system 200. A machine learning is recommended for the plurality of predictable fields in a ML recommendation module 212 using a machine learning recommendation technique.

The various modules of the system 100 for identifying predictable fields in an application for machine learning are implemented as at least one of a logically self-contained part of a software program, a self-contained hardware component, and/or, a self-contained hardware component with a logically self-contained part of a software program embedded into each of the hardware component that when executed perform the above method described herein.

Functions of the components of the system 200 are explained in conjunction with functional modules of the system 100 stored in the memory 102 and further explained in conjunction with flow diagram of FIGS. 3A and 3B. The FIG. 3A and FIG. 3B, with reference to FIG. 1, is an exemplary flow diagram illustrating a method 300 for using the system 100 of FIG. 1 for identifying predictable fields in an application for machine learning according to an embodiment of the present disclosure.

The steps of the method of the present disclosure will now be explained with reference to the components of the for identifying predictable fields in an application for machine learning (100) and the modules (202-212) as depicted in FIGS. 2 and the flow diagrams as depicted in FIG. 3A and FIG. 3B. Although process steps, method steps, techniques or the like may be described in a sequential order, such processes, methods and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

At step 302 of the method (300), a plurality of inputs associated with an application from a plurality of sources is received, via the input/output module 202. The plurality of inputs includes a plurality of predictability data attribute received from an application interface, a plurality of metadata received from an application database and a plurality of data attributes received from an application analytical source and a domain knowledge associated with a domain of the application received from a domain database.

In an embodiment, the application is a digitally enabled replica of an entity performing a digitally enabled task. The application can be one of a interface could be web interface, thick client, command line, virtual reality, voice interface, augmented reality, haptic interface or any other form that is capable of recording user inputs.

In an embodiment, the plurality of predictability data attribute is received from an application interface. In an example scenario the plurality of predictability data attribute is a user input data, wherein the predictability data attribute includes values entered in a text box in a web page. Further in an example scenario, the application interface is a web interface, a thick client, a command line, a virtual reality, a voice interface, an augmented reality, a haptic interface or any other form that is capable of recording user inputs.

In an embodiment, the plurality of metadata received from an application database, wherein the plurality of metadata holds information of the data attributes/entities, relationship details of the attributes and entities associated with the application. In an example scenario, the plurality of metadata includes an entity “Name” in an “Employee” table in a first application database could have a relation with another table that lists the reporting hierarchy from a second application database. Further the application database is a database configured to provide features to create triggers to track when the data gets created or modified in a system along with timestamp information.

In an embodiment, the plurality of data attributes received from an application analytical source. The plurality of data attributes is associated with data/information regarding a user's data, wherein the information includes details on how a data is keyed in, navigation flows of the data, frequency of access of the data. In an example scenario, the plurality of data attributes includes a list of how a user navigated a web page and which text field was entered, which button was clicked in what order and so on. Further the application analytical source gives information on the source code level interface elements. In an example scenario, application analytical source includes details on a plurality of html tags, associated with a user's actions.

In an embodiment, the domain knowledge associated with a domain of the application is received from a domain database. In an example scenario, the domain knowledge is available in the form of templates associated with a user interaction scenario, wherein the templates for insurance quotation will have details on all data attributes that are required to complete a quotation process. Further the domain database also provides the glossary of machine learning algorithms applied for a given domain process.

At step 304 of the method (300), the plurality of inputs is clustered, via the clustering module 204. The plurality of inputs is clustered based on a pre-defined parameter using a clustering technique to obtain grouped data using the domain knowledge. The grouped data is in tabular format with a plurality of rows and a plurality of columns. Further the grouped data is associated with a dimension/dimension parameter based on the plurality of rows and the plurality of columns.

In an embodiment, the pre-defined parameter is one of a time-stamp and a chronological order. In an example scenario, if C1, C2, C3, C4, C5 and C6 represent column names in a database, then the plurality of inputs is clustered based on a pre-defined parameter (here time stamp) to obtain grouped data as shown in below Table.1. For each instance of input edit, a timestamp value is stored against each column name, that represents the order in which data was entered as input.

TABLE 1
Grouped data

| C1 | C2 | C3 | C4 | C5 | C6 |
|---|---|---|---|---|---|
| 2017 | 2017 | 2017 | 2017 | 2017 | 2017 |
| Jul. 4 | Jul. 4 | Jul. 4 | Jul. 4 | Jul. 6 | Jul. 6 |
| 13:23:55 | 13:23:55 | 13:23:55 | 13:23:55 | 09:20:40 | 09:20:40 |
| 2017 | 2017 | 2017 | 2017 | 2017 | 2017 |
| Jul. 4 | Jul. 4 | Jul. 4 | Jul. 4 | Jul. 6 | Jul. 6 |
| 14:13:25 | 14:13:25 | 14:13:25 | 14:13:25 | 11:22:43 | 11:22:43 |

In an embodiment, the clustering technique comprises a similarity matching technique and a sequencing technique. In an example scenario the similarity technique includes one of a clustering technique (k-clustering), a bayesian network technique and so on. Further, in an example scenario the sequencing technique used in known in art and includes one of a Natural language processing technique such as an embedding method, a cosine similarity, a Euclidean distance method, a Jaccard distance method and so on.

At step 306 of the method (300), at least one pattern is identified in the grouped data based on the domain in the Pattern Identification Module 206. The at least one pattern is identified using a pattern identification technique. The at least one pattern is identified based on a correlation factor and a predictability factor for each of the plurality of columns within the grouped data.

In an embodiment, the pattern identification technique comprises of a similarity matching machine learning technique that comprises a clustering and a bayesian networks technique. In an example scenario, Bayesian networks utilizes a likelihood function and a hierarchical clustering minimize variance of Euclidian distance in variable space. During clustering, for a given set of n data input, each input variable generates it's on cluster. As the next step, if pairs of clusters are found to be similar, those are merged into a single cluster. In one implementation, similarity among clusters is assessed using distance measure like Euclidean, Manhattan etc. In another implementation, Bayesian learning algorithm based on expectation-maximization approach is used to determine the optimal number of clusters.

In an embodiment, the correlation factor is associated with similarity between at least two columns within the plurality of columns. The correlation factor is computed using can be expressed as shown below:

$${r}_{x y} = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

wherein,
r_{xy} is a correlation coefficient of the linear relationship between a variable x and a variable y,
xᵢ is a values of x in a sample,
x̅ is a mean of values of x,
yᵢ is a values of y in a sample, and
y̅ is a mean of values of y,

In an embodiment, the predictability factor is associated with a column's relevance to the domain and is a parameter that can be predicted. In an example scenario, the predictability factor is computed using a causal bayesian networks based on a joint probability function of three variables X,Y,Z can be represented as shown below

Pr(X, Y, Z)=Pr(X|Y, Z)Pr(Y|Z)Pr(Z)

At step 308 of the method (300), the grouped data is optimized in the optimizing module 208. The optimization is performed using an optimization technique based on the dimension to obtain an optimized grouped data.

In an embodiment, the optimization technique comprises of a dimension reduction technique to optimize the plurality of rows and the plurality of columns. In an example scenario, principal component analysis is used to optimize the plurality of rows and the plurality of columns wherein variables in columns/rows are combined to remove redundancies and emphasizes on problems that touch more variables at one time. Principal Component Analysis creates new/artificial variables that are created through a linear combination of original variables as shown in below example:

New variable=5*Variable2+20*Variable3−4*Variable2

At step 310 of the method (300), a plurality of predictable fields is identified in a Predictable Fields Identification Module 210. The plurality of predictable fields is identified from the optimized grouped data for the domain based on the pattern. The plurality of predictable fields comprises a set of predictable columns that are predictable and relevant to the domain.

In an embodiment, the plurality of predictable fields is identified based on Bayes method, which can be expressed as shown below:

P(C|X₁ . . . Xₙ)=απP(Xᵢ|C)P(C)

wherein:
features X are conditionally independent given the class variable C.

At step 312 of the method (300), a machine learning is recommended for the plurality of predictable fields in the ML Recommendation Module 212. The machine learning is recommended using a machine learning recommendation technique, wherein the machine learning is recommended based on a predictability score.

In an embodiment, the machine learning recommendation technique comprises of recommending at least a machine learning technique for the plurality of predictable fields from a machine learning database based on the predictability score.

In an embodiment the predictability score is expressed as an

Area Under Curve (AUC). In AUC, the value is equal to a probability that a machine learning model ranks a randomly chosen positive example higher than a randomly chosen negative example. The higher the value of Area Under Curve, better the predictability. Area Under Curve is the area under curve of false positive rate vs True positive rate which is represented as:

False Positive Rate=False Positive/(True Negative+False Positive)

True Positive Rate=True Positive/(False Negative+True Positive)

In another embodiment, the predictability score is defined based on Mean Squared Error. The mean squared error is an average of the square of the difference between the original and predicted values and can be expressed as shown below:

$$Mean square error = \frac{1}{N} {\sum }_{j = 1}^{N} {( {y}_{j} - {\hat{y}}_{j} )}^{2}$$

Further the plurality of predictable fields and the recommended machine learning for the plurality of predictable fields is shared with a user via the Input/output Module 202.

In an embodiment, a user feedback is obtained for the plurality of predictable fields and the recommended machine learning for the plurality of predictable fields. The user feedback is utilized to refine the plurality of predictable fields and the recommended machine learning for further purposes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

### Experiment

An experiment has been conducted using insurance data with 10,000 records. The disclosed method and system identified two fields as predictable fields among the 10,000 records. A sample record is extracted from the 10,0000 records and shown below in the Table.2 given below:

TABLE 2
A sample of the experimental insurance data

| State | Contact | | | Employment | | | Marital | Monthly | |
|---|---|---|---|---|---|---|---|---|---|
| Code | Type | Coverage | Education | Status | Gender | Income | Status | Premium | Last claim date |
| NJ | Email | Comprehensive | Bachelor | Employed | F | 56274 | Married | 75 | Jan. 2, 2020 |
| NY | Call | Comprehensive | Bachelor | Unemployed | F | 0 | Single | 100 | Mar. 2, 2020 |
| OK | Call | Premium | Bachelor | Employed | F | 48767 | Married | 150 | Mar. 5, 2020 |
| MO | Call | Basic | Bachelor | Unemployed | M | 0 | Married | 93 | Dec. 12, 2020 |
| KS | Call | Basic | Bachelor | Employed | M | 43836 | Single | 73 | Mar. 5, 2020 |
| IA | Email | Basic | Bachelor | Employed | F | 62902 | Married | 60 | Nov. 12, 2020 |
| IA | Email | Basic | College | Employed | F | 55350 | Married | 60 | Jan. 1, 2020 |
| NE | Email | Comprehensive | Master | Unemployed | M | 0 | Single | 101 | Jan. 3, 2020 |
| IA | Email | Basic | Bachelor | Medical | M | 14072 | Divorced | 71 | Apr. 4, 2020 |
| | | | | Leave | | | | | |

| | Months | | | | | | | |
|---|---|---|---|---|---|---|---|---|
| | Since | Number | | | | | | Total |
| State | Policy | of Open | Number of | Claim | Sales | Vehilce | Vehicle | Claim |
| Code | Incepti on | Complaints | Policies | Reason | Channel | Use | Size | Amount |
| NJ | 5 | 0 | 1 | Collision | Web | Leisure | Medsize | 384.811147 |
| NY | 42 | 0 | 8 | Scratch_Dent | Agent | Daily | Medsize | 1131.464935 |
| | | | | | | commute | | |
| OK | 38 | 0 | 2 | Collision | Agent | Leisure | Medsize | 566.472247 |
| MO | 65 | 0 | 7 | Collision | Call | Leisure | Medsize | 529.881344 |
| | | | | | Center | | | |
| KS | 44 | 0 | 1 | Collision | Agent | Leisure | Medsize | 138.130879 |
| IA | 94 | 0 | 2 | Hail | Web | Leisure | Medsize | 159.383042 |
| IA | 13 | 0 | 9 | Collision | Agent | Daily | Medsize | 321.6 |
| | | | | | | commute | | |
| NE | 68 | 0 | 4 | Collision | Agent | Leisure | Medsize | 363.02968 |
| IA | 3 | 0 | 2 | Collision | Agent | Daily | Medsize | 511.2 |
| | | | | | | commute | | |

The disclosed techniques of identifying predictable fields in an application for machine learning (ML) was applied to the 10,000 records (a sample of which is shown in the Table.2). Based on the disclosed techniques, “Total Claim Amount” and “Income” were identified as predictable fields with predictability score as 0.85 and 0.76 respectively.

The embodiment of present disclosure herein relates to identifying predictable fields in an application for machine learning (ML). With the availability of several choices for machine learning techniques, it is difficult to choose the most effective option on a specific application. In addition, the functionality/usage of fields within an application may vary across applications subject to the application's domain. Hence ML may not be efficient for all datatypes/fields. Therefore, the disclosure provides a method and system for identifying predictable fields in an application before recommending machine learning (ML) technique for the predictable field. The predictable fields are identified based on the domain of the application using a grouping technique, a pattern identification technique and a optimization techniques. Further ML techniques are recommended only on identified predictable fields. Hence making the ML process more effective on the application in relevance with the application's domain.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description.

Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored.

Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method comprising:
receiving a plurality of inputs associated with an application from a plurality of sources, via a one or more hardware processors, the plurality of inputs comprising a plurality of predictability data attribute received from an application interface, a plurality of metadata from received from an application database and a plurality of data attributes received from an application analytical source and a domain knowledge associated with a domain of the application received from a domain database;
clustering the plurality of inputs, via the one or more hardware processors, based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns;
identifying at least one pattern in the grouped data based on the domain, via the one or more hardware processors, using a pattern identification technique, wherein the at least one pattern is identified based on comprises a correlation factor and a predictability factor for each of the plurality of columns within the grouped data;
optimizing the grouped data, via the one or more hardware processors, using an optimization technique based on the dimension to obtain an optimized grouped data;
identifying a plurality of predictable fields, via the one or more hardware processors, from the optimized grouped data for the domain based on the at least one pattern, wherein the plurality of predictable fields comprises a set of predictable columns that are predictable and relevant to the domain; and
recommending a machine learning technique for the plurality of predictable fields, via the one or more hardware processors, using a machine learning recommendation technique, wherein the machine learning technique is recommended based on a predictability score.

2. The method of claim 1, further comprising sharing the plurality of predictable fields and the recommended machine learning for the plurality of predictable fields with a user to obtain a user feedback to refine the plurality of predictable fields and the recommended machine learning.

3. The method of claim 1, wherein the pre-defined parameter is one of a time-stamp and a chronological order and the clustering technique comprises a similarity matching technique and a sequencing technique.

4. The method of claim 1, wherein the pattern identification technique comprises a similarity matching machine learning technique that comprises a clustering and a bayesian networks technique.

5. The method of claim 1, wherein the correlation factor is associated with similarity between at least two columns from amongst the plurality of columns and the predictability factor is associated with a column's relevance to the domain and is a parameter that can be predicted using a machine learning technique.

6. The method of claim 1, wherein the optimization technique comprises of a dimension reduction technique to optimize the plurality of rows and the plurality of columns.

7. The method of claim 1, wherein the machine learning recommendation technique comprises of recommending at least a machine learning technique for the plurality of predictable fields from a machine learning database based on the predictability score.

8. The method of claim 1, wherein the predictability score is determined for each of the predictable fields from among the plurality of predictable fields based on a scoring technique and the machine learning techniques recommended are ranked and recommended based on the predictability score.

9. A system comprising:
an input/output interface;
one or more memories; and
one or more hardware processors, the one or more memories coupled to the one or more hardware processors, wherein the one or more hardware processors are configured to execute programmed instructions stored in the one or more memories to:
receive a plurality of inputs associated with an application from a plurality of sources, via the one or more hardware processors, the plurality of inputs comprising a plurality of predictability data attribute received from an application interface, a plurality of metadata from received from an application database and a plurality of data attributes received from an application analytical source and a domain knowledge associated with a domain of the application received from a domain database;
cluster the plurality of inputs, via the one or more hardware processors, based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns;
identify at least one pattern in the grouped data based on the domain, via the one or more hardware processors, using a pattern identification technique, wherein the at least one pattern is identified based on comprises a correlation factor and a predictability factor for each of the plurality of columns within the grouped data;
optimize the grouped data, via the one or more hardware processors, using an optimization technique based on the dimension to obtain an optimized grouped data;
identify a plurality of predictable fields, via the one or more hardware processors, from the optimized grouped data for the domain based on the at least one pattern, wherein the plurality of predictable fields comprises a set of predictable columns that are predictable and relevant to the domain; and
recommend a machine learning technique for the plurality of predictable fields, via the one or more hardware processors, using a machine learning recommendation technique, wherein the machine learning technique is recommended based on a predictability score.

10. The system of claim 9, wherein the one or more hardware processors are configured by the instructions to share the plurality of predictable fields and the recommended machine learning for the plurality of predictable fields with a user to obtain a user feedback to refine the plurality of predictable fields and the recommended machine learning.

11. The system of claim 9, wherein the one or more hardware processors are configured by the instructions to perform the clustering technique, pattern identification technique and optimization technique wherein the clustering technique comprises a similarity matching technique and a sequencing technique, the pattern identification technique comprises of a similarity matching machine learning technique that comprises a clustering and a bayesian networks technique and the optimization technique comprises of a dimension reduction technique to optimize the plurality of rows and the plurality of columns.

12. The system of claim 9, wherein the one or more hardware processors are configured by the instructions to perform the machine learning recommendation technique, wherein the machine learning recommendation technique comprises of recommending at least a machine learning technique for the plurality of predictable fields from a machine learning database based on the predictability score.

13. The system of claim 9, wherein the one or more hardware processors are configured by the instructions to determine the predictability score for each of the predictable field among the plurality of predictable fields based on a scoring technique and the machine learning techniques recommended are ranked and recommended based on the predictability score.

14. One or more non-transitory machine-readable information storage mediums comprising one or more instructions which when executed by one or more hardware processors cause:
receiving a plurality of inputs associated with an application from a plurality of sources, via a one or more hardware processors, the plurality of inputs comprising a plurality of predictability data attribute received from an application interface, a plurality of metadata from received from an application database and a plurality of data attributes received from an application analytical source and a domain knowledge associated with a domain of the application received from a domain database;
clustering the plurality of inputs, via the one or more hardware processors, based on a pre-defined parameter using a clustering technique to obtain grouped data using the domain knowledge, wherein the grouped data is in tabular format with a plurality of rows and a plurality of columns and the grouped data is associated with a dimension based on the plurality of rows and the plurality of columns;
identifying at least one pattern in the grouped data based on the domain, via the one or more hardware processors, using a pattern identification technique, wherein the at least one pattern is identified based on comprises a correlation factor and a predictability factor for each of the plurality of columns within the grouped data;
optimizing the grouped data, via the one or more hardware processors, using an optimization technique based on the dimension to obtain an optimized grouped data;
identifying a plurality of predictable fields, via the one or more hardware processors, from the optimized grouped data for the domain based on the at least one pattern, wherein the plurality of predictable fields comprises a set of predictable columns that are predictable and relevant to the domain; and
recommending a machine learning technique for the plurality of predictable fields, via the one or more hardware processors, using a machine learning recommendation technique, wherein the machine learning technique is recommended based on a predictability score.
